(19) United States
(12) Patent Application Publication
(10) Pub. No.: US 2013/0344464 A1
(43) Pub. Date: Dec. 26, 2013

(54) PERSONALITY PROFILING SYSTEM AND METHODS FOR USE IN ALL TYPES OF COMMUNICATIONS AND INTERACTIONS

(71) Applicant: Brandy Mychals, Lafayette, CA (US)

(72) Inventor: Brandy Mychals, Lafayette, CA (US)

(21) Appl. No.: 13/831,571

(22) Filed: Mar. 14, 2013

Related U.S. Application Data
(60) Provisional application No. 61/611,007, filed on Mar. 14, 2012.

(51) Int. Cl. G09B 19/00

(52) U.S. Cl. CPC G09B 19/00
USPC 434/236

(57) ABSTRACT

Methods and systems for assessing an individual's character, temperament, speed, positive and negative behavior based on the individual's innate personality (nature) and impact of environment (nurture) are described. A predictable method of assessment is based on the individual's appearance (physical choices including hair, makeup, accessories, clothing), presentation (body stance, facial expressions, energy, attitude, carriage, pacing), and speaking (word usage, tone, inflection, speed and sound). The assessment also includes a psyche section which details the “why” behind the individual's behavior, the positive and negative traits, driving needs, typical career choices, relationship patterns and more. The psyche section may also include the mental status, internal dialogue (intra-communication), outward behavior and patterns of dialogue with others (inter-communication). The methods and systems include assessment on all levels of visual, auditory and sensing data to determine a Character Code. The Character Code may be an Activist, Actor, Artist, Cheer leader, Class President, Scholar or any combination of the Character Codes.

### RELATED APPLICATION

This patent application claims the benefit of U.S. Provisional Patent Application No. 61/611,007 filed on Mar. 14, 2012, which hereby is incorporated by reference.

### TECHNICAL FIELD

The present invention relates to a multi-dimensional profiling procedure for assessing and evaluating extensive personality traits and modes of behavior, function, and relatability. More particularly, the present invention pertains to a profiling method and system for measuring the strengths, challenges, interpersonal skills present based on temperament, environment, training, and predictive situational behavior.

### BACKGROUND

Multi-dimensional models of behavior have been in existence since about 400 BC with Empodocles (air, earth, fire, and water). Through recorded time, many others have contributed systems to understand observed personalities, including Hippocrates in 370 BC (sanguine, choleric, phlegmatic, and melancholic), Galen in 170 AD, Carl Jung in 1921 (thinking, feeling, sensing, and intuiting), and William Marston in 1928 (dominance, inducement, steadiness, and compliance). More modern models include the Myers-Briggs Type Indicator (MTBI®), the DISC®, and the Strength Deployment Inventory (SDK)) personality assessment tools.

In general, the MBTI® assessment tool illuminates ways of thinking and dealing with information internally. That is, how we think about the world around us. This test sorts psychological differences into four opposite pairs, or dichotomies, with a resulting 16 possible psychological types.

The DISC® assessment tool illuminates one's behavioral style, that is, how we do what we do. It is a quadrant behavioral model that characterizes an individual as having a mixture or four dimensions: 1) Dominance relates to control, power and assertiveness; 2) Influence relates to social situations and communication; 3) Steadiness relates to patience, persistence, and thoughtfulness; and 4) Caution/compliance relates to structure and organization.

In general the SDI® personality assessment tool determines why individuals do the things they do when things are going well and when faced with conflict and opposition. It uses colors to identify personality traits: Red for Assertive/Directing; Green for Analytic/Autonomizing; and Blue for Altruistic/Nurturing.

### SUMMARY OF INVENTION

A method of analyzing an individual and interacting most effectively therewith, the method comprising: a) analyzing an individual by assessing details of appearance, presentation, and verbal communication to determine at least one of a character pattern selected from the group consisting of an Actress, Class President, a Cheerleader, a Scholar, an Activist, and an Artist; b) using the determined character type to establish an individual's likely propensities in areas selected from needs, traits, negative internal drivers, conflict/stress/emotions, health/wellness, jobs/careers, and reaction to marketing sales; c) sorting through the likely propensities of the individual to determine if that individual is an ideal client or colleague for personal development, awareness, business, sales, marketing, conflict resolution, personal relationships, parenting, or professional relationships; and d) tailoring the direction of the marketing, selling, communications or other interaction to the individual's propensities.

The method of claim 1 wherein the details of appearance comprise hair style and grooming, application and choices of makeup, choice and wearing of accessories, style and length of nails, facial and body grooming, style and selection of clothing types of personal carry bag, and footwear.

The method of claim 1 wherein the details of presentation comprise demeanor, bodey stance, posture, carriage, movement such as pacing, eye contact, physical distance between individuals, body language such as hand gestures, facial expressions, energy level, actions and attitude.

The method of claim 1 wherein the details of verbal communication comprise word usage, tone, inflection, speed, sound and typical phrases.

The method of claim 1 wherein the details of driving needs comprise certainty, variety, significance, connection, predictability, control, adventure, newness, vulnerability, humanity, uniqueness and individuality.

The method of claim 1 wherein the character pattern of Actress comprises significance, uniqueness, individuality, big hair, full makeup, dramatic jewelry, bright clothing, dramatic or brightly colored shoes, talkative, projecting power, and high energy.

The method of claim 1 wherein the character pattern of Activist comprises connection, vulnerability, humanity, longer and less styled hair, slight makeup, natural-material jewelry, natural-fiber, earth-toned clothing, comfortable shoes, calming energy, and hugging.

The method of claim 1 wherein the character pattern of Artist comprises significance, uniqueness, individuality, stylized and colored hair, eclectic clothing, wide range of foot coverings,

The method of claim 1 wherein the character pattern of Cheerleader comprises variety, adventure, newness, friendliness, neighborly image, shoulder-length hair, full makeup, feminine or metrosexual clothing, romantic jewelry, up-beat, talkative, connecting with people, encouraging others, and interrupting to share an idea.

The method of claim 1 wherein the character pattern of Class President comprises certainty, predictability, control, professional image, driven, powerful, tasteful haircut; classic jewelry, tailored clothing that is often black, making eye contact, accomplished and effective.

The method of claim 1 wherein the character pattern of Scholar comprises certainty, predictability, control, studious, analytical, methodical, minimal or absent makeup, simple clothing, practical shoes, minimal or no jewelry, limited eye contact, task oriented, trouble shooters, creative, deliberative and questioning.

### BRIEF DESCRIPTION OF THE DRAWINGS

FIG. 1 shows the graphics for an Activist Character Code that incorporates typical appearance, presentation, and psyche traits according to the inventions.

FIG. 2 shows the graphics for an Actor Character Code that incorporates typical appearance, presentation, and psyche traits according to the inventions.

FIG. 3 shows the graphics for an Artist Character Code that incorporates typical appearance, presentation and psyche traits according to the inventions.

FIG. 4 shows the graphics for a Cheerleader Character Code that incorporates typical appearance, presentation and psyche traits according to the inventions.

FIG. 5 shows the graphics for a Class President Character Code that incorporates typical appearance, presentation and psyche traits according to the inventions.

FIG. 6 shows the graphics for a Scholar Character Code that incorporates typical appearance, presentation and psyche traits according to the inventions.

### DETAILED DESCRIPTION

To improve my ability to relate to patients and other individuals and to improve my practice as a chiropractor, I studied multiple profiling systems including extensive analysis and dissection of the DISC® and MTBI® systems. As a chiropractor, I observed human behavior in health and under stress. A break-through occurred when I made the correlation that people were “showing” up as different personality types. I started testing my observations and making notations with clients. As I developed my own system, I reexamined my system based on existing systems. Based on these data and inputs, I drew up the profiles (each Character Code® description) and presented the information to a test group. I originally tested 1432 clients by observation, then tested 1000's of clients in person and remotely through business training (13,754 to date via live trainings, virtual, online) and almost 1000 take the initial quiz online at www.charactercode.com/quiz. I have tested aspects of the system and demonstrated that the system is effective in the following arenas: self-assessment, business relationships, marketing, sales, personal relationships, etc. My new system largely differs from previous models in that it is a sextuple-type model; includes assessment based on visual, auditory, and sensing stimuli; with optional testing. My model ties all this together and includes visual and auditory components. In the past, behavior or thoughts were addressed. This is the first system to put together visual, auditory, body language, behavior and thoughts/motivation. I have connected the deep and superficial models as well as nature vs. nurture concepts.

My system also includes methods to use the individual's profile to decide if one can socialize or work with the individual, to market and to sell to the individual more effectively based on the behavioral predictions in my system. Methods and systems for assessing an individual's character, temperament, speed, positive and negative behavior based on the individual's innate personality (nature) and impact of environment (nurture) are described herein.

I started with an assessment of an individual via the three visual communication factors which collectively comprise 100% of a person's first impression. For example, appearance may account for about 55% of a person's first impression of an individual. These are 3 components of a First Impression—the judgments we make based on likeability. [Mehrabian, A. “Silent Messages: Implicit Communication of Emotions and Attitudes”, Belmont, Calif.: Wadsworth. (1981)]. As for what we see, 55% of your first impression is based on your appearance and presentation. Appearance includes your hair, makeup, jewelry, nails, clothing, accessories and shoes. Presentation includes your body language, posture, facial expressions and physical communication. As for what sounds we hear, 38% is your vocal tone, and includes the sound of your voice, volume, quality, pitch and resonance. As for what words we hear, 7% is your speaking, the actual words and phrases you express.

My assessment also includes a psyche section which details the “why” behind the individual's behavior, the positive and negative traits, driving needs, typical career choices, relationship patterns and more. As used herein, the term psyche encompasses the specialized cognitive, conative, and affective aspects of a psychosomatic unity, specifically the totality of the id, ego, and superego including both conscious and unconscious components. In other words, psyche may encompass everything related to an individual's soul, personality and mind. The term “personality” may be used interchangeably with the term “psyche” and is not meant to be limiting in any way. My psyche section is revolutionary in that it includes the mental status, internal dialogue (intra-communication), outward behavior and patterns of dialogue with others (inter-communication).

These assessments include all levels of visual, auditory and sensing data and are used to determine which Character Code represents the individual. Character codes include the following character types: Class President, Cheerleader, Actor/Actress, Scholar, Activist, and Artist. As used herein, the Character Codes are gender neutral and apply to both males and females unless specified otherwise. For example, the factor of “appearance” may be defined differently for a male than a female. The terms “Actor” and “Actress” may be used interchangeably and are not limited in any way.

In my system, appearance includes physical choices including hair style and grooming; application and choices of makeup; choice and wearing of accessories; style/length of nails; facial and body grooming; style/selection for clothing; style/selection of a personal carry bag such as a briefcase, purse, backpack, tote, luggage and the like; and style/selection of footwear. Clothing selection may further be assessed by style (fashion choice or trend), tidiness (trim, tucked, loose, casual, dressy), color (bright, light, dark, muted, full color spectrum), length (long, short, medium), use (new, worn or damaged), texture (fabric, pattern, design) and/or tailoring (tight, flowing, layered).

Presentation includes demeanor; body stance; posture; carriage; movement such as pacing; body language such as hand gestures; physical movements and facial expressions; energy; actions; and/or attitude. Presentation may also include an assessment of speed/pacing (fast, slow), excessive/subtle, expressive/reserved, impact of activity on other individuals (infectious smile, stress inducing, avoidance response, fear), physical distance/space between individuals (tight, average, far) and/or eye contact (steady, wavering, avoidance). In one embodiment, attitude may be characterized as two opposites such as introversion and extroversion; fast and slow; people-oriented and task-oriented; and the like.

Speaking includes word usage, tone, inflection, speed, and sound. Speaking may also be assessed by speed (fast, slow, long pauses, quick response, interrupt, blurt), tone (harsh, melody, monotone, low, high), and/or typical phrases.

The psyche section accounts for who the individual is and what they care about. The psyche section is important for finding the best way to connect to others. The psyche section includes an assessment of values, fears, dreams, nightmares, driving needs, stresses, and strengths and challenges for an individual. The psyche section may also identify which of the Character Codes get along or clash, are drawn to each other or stay away from each other. The psyche section also provides clues or other indicators that allow a person to identify what another person values the most. Finally, the psyche section provides clues or other indicators that enable a person to powerfully connect with another person in any situation such as in a group, as an individual, in person, over the phone, or online.

My system goes another step further in assessing the individual's psyche by using noted Character Traits (typical and predictable characteristics/behaviors), driving needs (one of four driving needs most valued by each individual), emotions/stress/conflict (how positive/negative emotions are expressed, how they handle and view conflict), relationships (likely compatibility/connection with other individuals, detailed response to stimuli of other individuals), health/wellness (predictable patterns of behavior in self-care and resulting health), parenting (pattern of behavior in child rearing and impact of their own childhood), sex (how the individuals respond to partners in sex and likely choices for a mate), marketing (how to reach the individual in marketing in person, in product, in print and online), sales (predictable response to sales, money, business) and/or a person's negative internal drivers or “Inner Meanie” (critical inner voice of doubt/fear/insecurity and where/why it occurs).

Each individual has driving individual needs of certainty, variety, significance and connection. The different Character Codes have different Driving Needs as follows: Certainty, predictability, control (Class President, Scholar); variety, adventure, newness (Cheerleader); Significance, uniqueness, individuality (Actor, Artist); and connection, vulnerability, humanity (Activist).

The one driving need for each Character may be attributed to both birth and environment and continues to strongly drive behavior and choices in their appearance, presentation, and speaking The functionalities of an individual's psyche may also be used to determine an individual's Character Code/type/temperament. These functionalities may be based upon the opposed driving needs, nature/nurture experience and the expression of this in their appearance, presentation, speaking and psyche.

In one embodiment, an individual may be assessed as a single Character Code/type/temperament or a combination of the two highest ranked Character Code/type/temperament categories. A preference Character Code/type/temperament may be determined by identifying a dominant driving need and display of appearance, presentation, speaking and psyche. A preference Character Code/type/temperament may also be determined by identifying a secondary driving need and display of appearance, presentation, speaking and psyche.

In one embodiment, a sextuple-type model having six Character Codes/types/temperaments may be used to characterize an individual. The six Character Codes/types/temperaments may include Activist, Artist, Actor, Cheerleader, Class President, and Scholar.

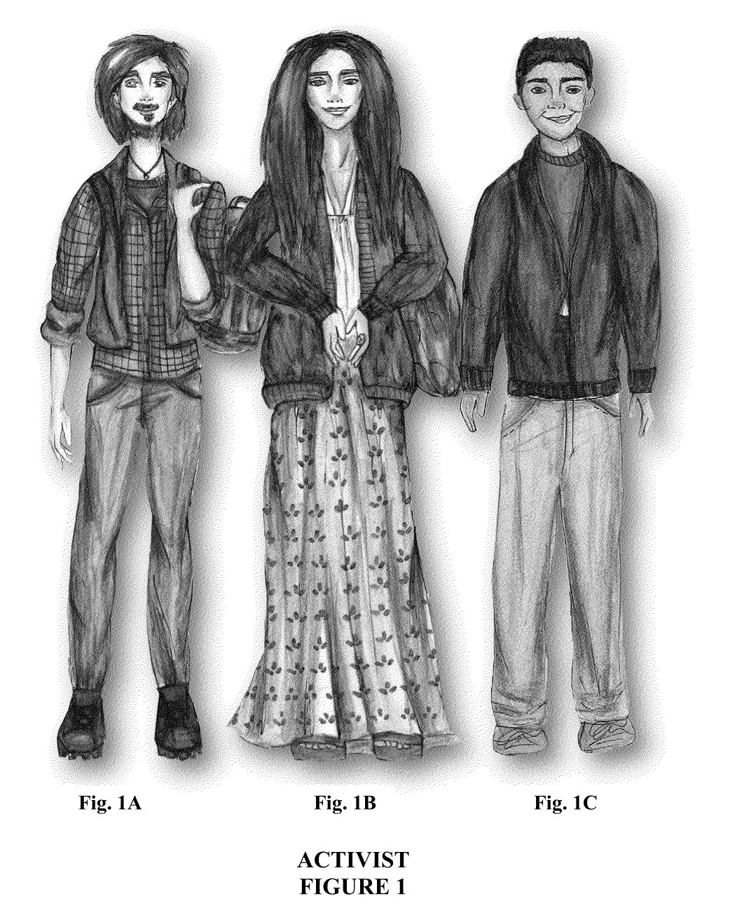

The Activist is generally speaking is someone who is ready to take up a cause and cares a great deal about people, animals and feelings. FIG. 1 shows a typical appearance, presentation, and psyche characteristics of an Activist. With respect to an Activist's appearance, most of the following are noted: Hair is typically long (maybe for men, too), most natural look and often the least styled. Makeup is often slight or natural. In fact, when you see a woman with no makeup, she is likely an Activist. Jewelry may include beads or metals, most likely favors stones, shells, quartz. Clothing likely includes natural fibers, earthy colors, and the layered look. Purse/bag is most likely to have a long handle that would fit over her head and across the opposite shoulder, and men often carry a backpack. Shoes are likely to be flats, sandals, with comfort a priority and could also be tennis shoes or hiking shoes (especially with men).

With respect to the presentation an Activist typically loves to project a calming energy. They will typically be the most fluid in their body stance. An Activist is likely to make eye contact and hold eye contact. An Activist may be a hugger that holds hugs, shakes hands with two hands, or double hand shake.

With respect to speaking, the Activist is a listener. They may wait their turn before responding, pause to take it in before answering, and talk in a steady, even tone.

With regard to the psyche of an Activist, driving needs are an inner desire for connection to people and spirit and a desire for peace as in a calmness, comfort and assurance in their day-to-day life. The Activist may have the need for assurance and peace which can sometimes hold the Activist back and make them adverse to risk. They may desire to be understood and accepted for who they really are. They move at a slower pace and are likely not to be impulsive. The Activist typically enjoys being part of a community, doesn't necessarily enjoy traditional sports and believes in cooperation and not competition. The Activist's “inner meanie” may be one that tells them that they are not capable and often beat themselves up for not being like the other faster-paced Character Codes around them. One of the Activist's greatest strengths is being able to connect with people on a deep level.

Activists prefer being around other Activists and less so with Artists and some Cheerleaders. They are least compatible with Actresses. Activists may unnerve Class Presidents who are surprised at how much personal information is shared. In turn, Activists are sometimes repelled by the aggressive and assertive behavior of other types. As potential customers, Activists need to connect with you first and know that you are authentic, caring and genuine, so get to know them and their circle. They desire to be accepted for who they really are. Activists are not motivated by urgent language, which is very important in how I approach them as clients. Activists definitely weight their decisions on purchases carefully, placing weight on their intuition and a group consensus. If your Character Code is impatient, Activists are frustrating because of the long sales cycle.

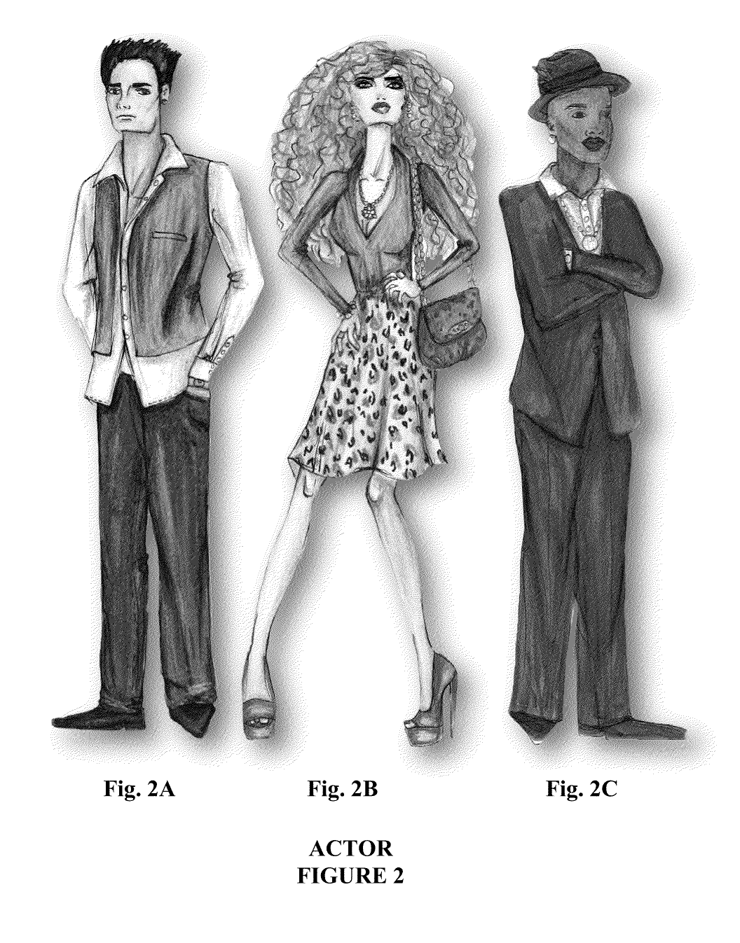

The Artist may be very creative and somewhat similar in personality to the Activist but with a keen fashion sense. FIG. 2 shows a typical appearance, presentation, and psyche characteristics of an Artist. With respect to an Artist's appearance, some or all of the following are present. Hair is typically a stylized haircut. The Artist is most likely to have a short, spiky hairdo for women; men may have a “retro” hair style. Clothing may be eclectic (may shop at vintage stores). The Artist enjoys looking different from everyone else. Shoes range from heels to boots; men may wear wing tips.

With respect to presentation, an Artist's overall demeanor is likely too cool for words. An Artist may create a barrier in relating to others. An Artist may stand at a distance and wait to be approached.

With respect to speaking, the Artist often is reserved or withholding. Like the Activist, an Artist is likely to be a good listener.

With regard to an Artist's psyche, the Artist is typically driven by a desire for significance. The Artist also appreciates connection, but it is the drive for uniqueness that sets him apart and initiates his fashion choices. Artists may be assumed to be judgmental because they appear so unique. In reality, Artists are likely to be the most accepting of all Character Codes. Artists are likely to be turned off by anyone that is “salesy”. They typically want authenticity and represent a longer sales cycle and are very loyal. The Artist's “inner meanie” may be one that tells them that they are not special. Depending on their level of dealing with this, they may be working overtime to display their uniqueness via self-expression and activity. One of an Artist's greatest strengths is being able to see and allow for someone else's individuality.

Unlike Activists, Artists want to be recognized for their unique work, gifts and talents. Artists are the best Character Code for handling a difficult Actress. As purchasers, Artists weight their decisions carefully and appreciate individual work and attention. If Artists are your ideal clients, you need to consider the visual and verbal message you must send. Help an Artist connect by reflecting back some of what they appreciate. They do not appreciate automated cards; create different systems and structures to attract them and show that you “get” them.

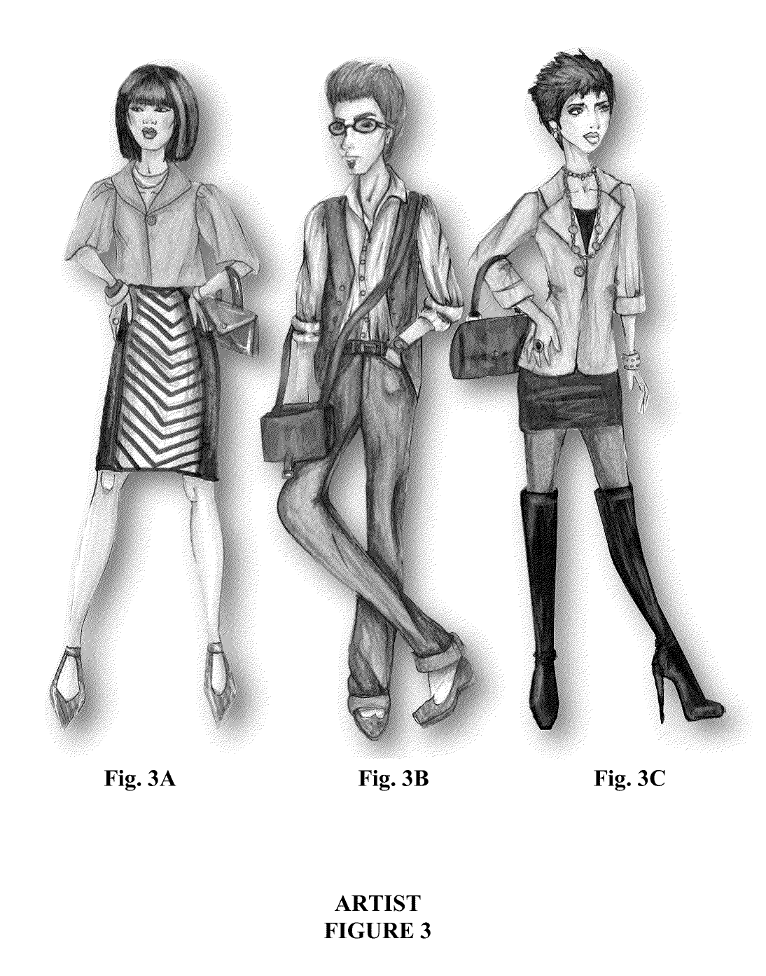

The Actor/Actress will typically describe themselves as bigger, bolder and better. FIG. 3 shows typical appearance, presentation, and psyche characteristics of an Actor. With regard to appearance, some or all of the following are present: Hair is likely to be big (untamed for men, styled for women). Makeup is full and more than other Character Codes. Jewelry is likely to look dramatic. Clothing is often brightly colored, geometric patterns, skin prints or large floral prints. Men may wear bright colors and big patterns or “wild” ties. Shoes are also dramatic and are likely to be sexy and usually heeled. Men may wear brightly colored shoes.

With regard to presentation, Actors are likely to project power and be high energy. They typically fill a room and are very commanding.

With regard to speaking, an Actor is likely a talker and a blurter. They typically talk louder and are less aware of their surroundings and have a strong sense of humor.

With regard to psyche, an Actor is likely to be driven to be right. They typically crave praise, attention, leadership, validation and authority. The Actor is usually fast paced, commanding and always noticeable. Actors may move people into action and cause social change. Without a proper outlet, they can tear down the greatness in others and can inflame a crowd. An Actor may have true influential power and their presence is palpable. The Actor's “inner meanie” may be one that tells them that they're not good enough, or pretty enough or talented enough and sometimes not worthy of love. One of the Actor's greatest strengths is their ability to move mountains when their energy is effectively channeled.

As purchasers, the Actress can be the most challenging because they make a quick decision but can then become easily overwhelmed and may not follow through, and it can be difficult to capture their attention and earn their respect. If the Actress is your ideal client, you will need to structure your business model to allow for their behavioral style, and remember that they can be a bit inflammatory. They can be a bit blunt and insensitive, but once won over, they are very loyal and can even become your champion. You will need to set firm and set clear boundaries, else they will roll over you and even try to rewrite your own rules. Be sure your message is sttong, powerful and full of confidence, to come across as an equal and win the Actress' respect. Use a very firm handshake, look into their eyes and be unwavering. If you are an Actress/flamboyant personality/storyteller, other Actresses may not want to be around you to share the lime light. Actresses tend to prefer the more compliant Cheerleader or maybe an Activist, but most activists are scared to the overpowering Actress. Artists are the most compatible with Actresses.

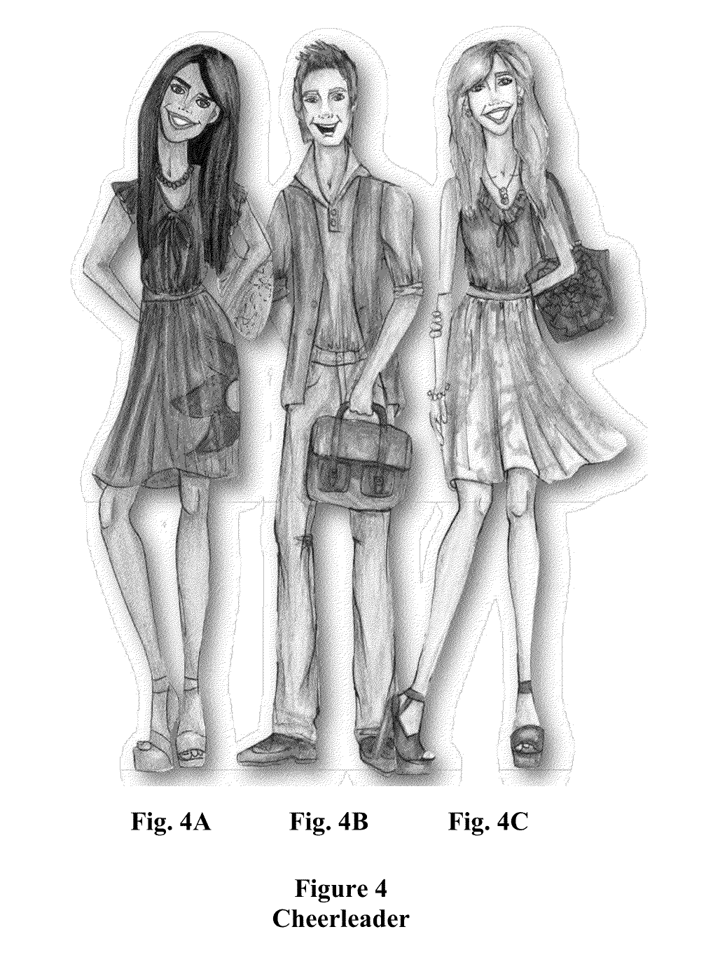

In contrast, the Cheerleaders are typically bubbly, friendly, flirty; males are often “metro-sexual”. FIG. 4 shows a typical appearance, presentation, and psyche characteristics of a Cheerleader. With regard to appearance, some or all of the following are noted: Hair is typically shoulder length that can be bouncy or pulled into a ponytail, and ranges from short to surfer style for men; clothing is likely to be feminine, likely a skirt or dress; men may wear pastel dress shirts or more color and are stylish in their appearance; only female Cheerleaders wear makeup, which is usually full but tastefully done; overall look is the “girl-next-door” or “boy-next-door”. Jewelry is likely to be anything that looks romantic—meaning delicate, dainty, fragile or airy and is more pretty than powerful; beads, glass, flowers and ribbons indicate a Cheerleader.

With regard to presentation, a Cheerleader is likely to project feminine energy; men are likely to be upbeat and friendly. Cheerleaders are likely to be seen laughing, giggling and smiling. They may lightly rest hands on people when they talk. They typically flit from person to person. Sometimes a Cheerleader appears rushed. They show when they are overwhelmed, whereas, a Class President hides it.

With regard to speaking, Cheerleaders are typically talkers and blurters. They may interrupt, not because they are rude, but because they want to share an idea. Cheerleaders typically enjoy connecting with people and giving compliments. Many motivational speakers are Cheerleaders.

With regard to psyche, the Cheerleader typically wants to make things fun. Cheerleaders may seek approval from others and can struggle with saying “No”. Typically a Cheerleader's greatest fear is to be alone. They may get bored easily and lose interest in activities that are not fun. The Cheerleader's “inner meanie” may be one that tells them they're not important. They want to share a feeling, which is not always accepted. One of the Cheerleader's greatest strengths is being able to turn a negative situation into a positive one and encouraging others. Their driving need is variety. The Cheerleader is fast paced and persuasive.

As purchasers the Cheerleader definitely gets caught up in the feeling, buying on emotion and placing huge weight on intuition and gut feelings. Cheerleaders like to accomplish things to get positive reactions from those around them and seek approval and praise. They are good at diffusing situations as they strive to have fun and keep things lighthearted. They make others feel good about themselves and they make a regimen fun. They get frustrated with routines and are the most likely Character Code to back out of a commitment. If a Cheerleader is your ideal client, make sure to emphasize you are fun to work with. Because the Cheerleader is spontaneous and impulsive, make sure you are clear about your refund policies and that you really present the benefits of your program. You often have to chase them, as they over-commit. Cheerleaders are happiest around other Cheerleaders, but they also get along with Activists and sometimes Actresses. They are least compatible with Scholars.

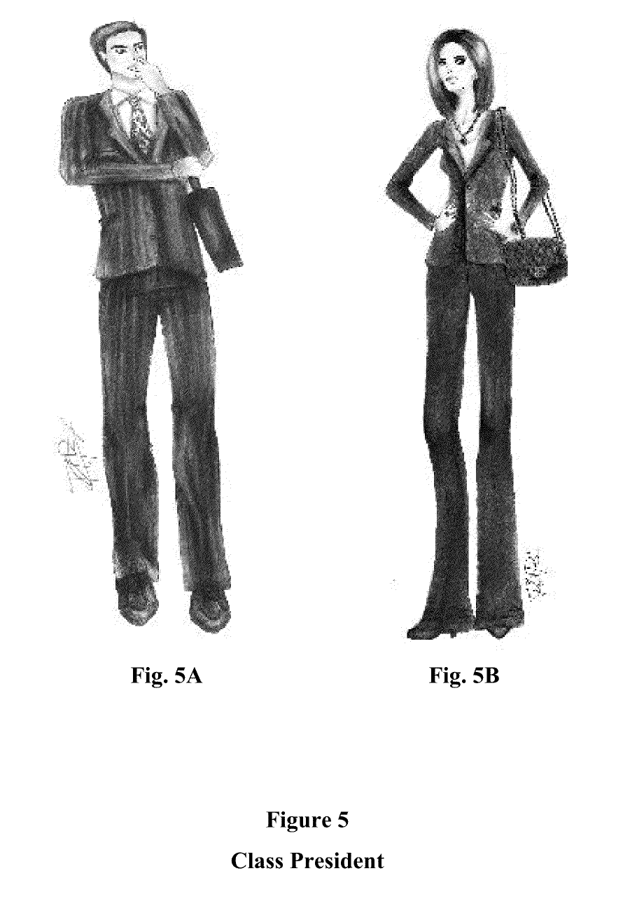

The Class President is typically professional, successful and driven. FIG. 5 shows a typical appearance, presentation, and psyche characteristics of a Class President. With regard to appearance, some or all of the following are noted: Hair is typically a tasteful bob for women, classic and short for men; jewelry is typically classic, timeless and tasteful; clothing is usually tailored and black is a favorite color; men usually wear suits and dress up, not down.

With regard to presentation, the Class President typically loves to project power. They usually stand tall, make eye contact and appear to be busy or thinking-strategizing about what comes next.

With regard to psyche, the Class President typically wants to do things right. They usually move from one challenge to another without reflecting on accomplishments. Their driving needs are certainty and control. They are typically the most judgmental of the other Character Codes and make immediate assumptions and decisions. The Class President's greatest strength is being able to handle almost any situation that comes their way.

As purchasers, Class Presidents are quick and definitive—provided you know what to say. They are the most judgmental of the Character Codes, usually because they are so hard on themselves. They may be unaware of others' personality differences and not realize they leave behind problems as they move from solving one problem to the next. If you are in the health niche and you want Class President clients, expect that many of them will want you to “just fix the problem.” It is possible to engage them in the process by relating the regimen to results, particular to maintaining income generating ability. Class Presidents like to feel in control. Meet them as equals with careful dress, headshot, website, colors, titles, etc. Good Class President colors are blue, black, gray, brown, white or some other jewel color, which avoiding earth colors, neutrals, pastels or anything too flamboyant. Your message conveys competence, trust and success. Class Presidents prefer to be around other Class Presidents; don't appear unsure or waiver in discussing your with them or they assume you do not know what you are talking about.

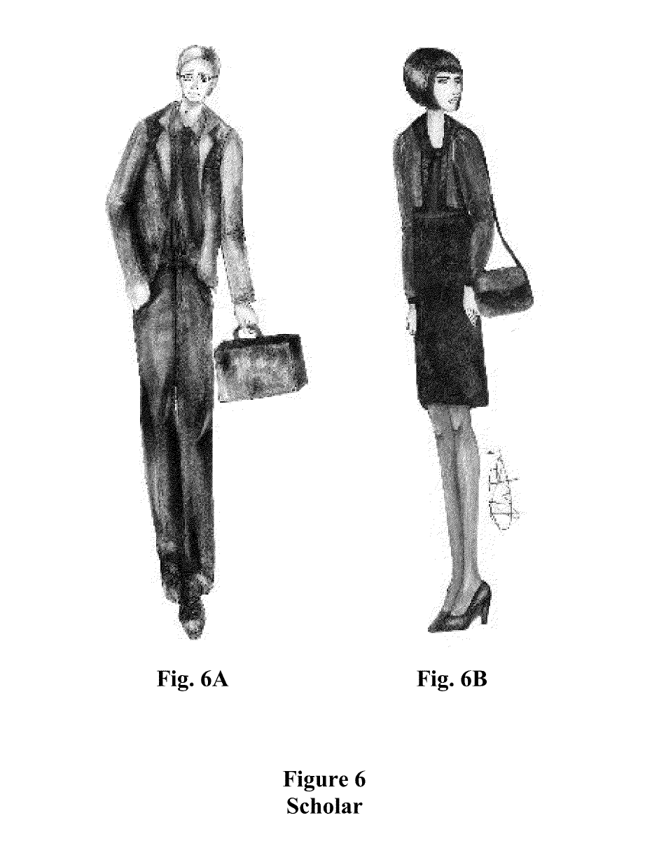

The Scholar is typically studious, analytical and methodical. FIG. 6 shows a typical appearance, presentation, and psyche characteristics of a scholar. With regard to appearance, some or all of the following are noted: Women's hair is usually a chin-length bob, long or a ponytail, with every strand in place, a simple wash and go style; men typically have a conservative and short hairstyle. Makeup is often minimal. Clothing is typically simple and solid colors. Shoes are usually practical. They may be hard to pick out of a crowd, but they often are a little disheveled. They often wear no jewelry as they prize function over fashion.

With regard to presentation, the Scholar typically loves to project a knowledgeable attitude. They typically hold themselves straight up and down. They are usually not good at making eye contact.

With regard to speaking, the Scholar is usually a researcher and likes data. They are not verbose and typically ask questions to gather information. They often don't communicate with ease and are not fans of hugging.

With regard to psyche, the Scholar typically prefers a binary language of yes and no, right and wrong, black and white. The driving need for certainty and task orientation may prevent Scholars from making impulsive decisions. Scholars are typically logical and pragmatic, not spontaneous and impulsive. They usually are great at troubleshooting and have high executive reasoning skills. Scholars typically struggle relating to people and may become entrenched in their way of doing things. If challenged, they may hold grudges. The Scholar's “inner meanie” may be one that tells them that they are not smart enough or that they did not do it right. One of the Scholar's greatest strengths is being able to create the process and then execute the steps.

Scholars can run into trouble with group dynamics if challenged. In marketing to Scholars, acknowledge their intellect and reasoning and emphasize that you have a proven system. Selling to Scholars can be a slow selling cycle because the Scholars need to think through the decision and weigh many details. Scholars prefer to be around other Scholars. Scholars may also like being with the Class Presidents due to directness and focus on tasks. They are incompatible with Cheerleaders and Actors, although they may find them socially intriguing.

The above described systems and methods may be used for personal development, awareness, business, sales, marketing, conflict resolution, all types of personal and professional relationships ranging from romantic partners to supervisors, parenting and the like. The systems and methods may include the hard/soft science of first impressions, assumptions and judgments to include the decision of the person making the first impression and how it is filtered or interpreted by the individual receiving the first impression. The systems and methods described herein have an advantage over other personality assessment tools in that users get a basic grasp of the system almost immediately using the visual images and descriptions. The names of each Character Code/type/temperament are user-friendly, evoke a visual image and impression, are memorable and can be easily repeated and used.

There are four combinations that are common. You will see them everywhere you go. They are: 1) The Class President/Cheerleader; 2)The Cheerleader/Activist; 3) The Activist/Scholar; and 4) The Scholar/Class President.

The Class President/Cheerleader combinations are risk-takers. They are decisive, move fast, have a big vision and can outline the steps it takes to accomplish it. They have a high tolerance for stress, pressure and pace. They often grow quickly and excel as leaders. You will find many of these combinations in sales, speaking and executive roles. They often have the ambition and drive to head up large organizations. They need to be mindful of growing too fast, taking on too many tasks or roles, or assuming too much risk. They often struggle with issues of delegation, leverage, and scalability.

The Cheerleader/Activists are people persons. They struggle the most with tasks and details. They often have a big vision, many ideas, and dreams to make a difference in the world. They are typically very kind, deep-feeling people motivated by serving and not sales. They are often challenged with money, saying “no”, time management and finding their own voice. With the combination of a driving need for variety and connection they often start new activities or meet new people and then bounce off to the next group. This doesn't allow enough time or exposure for something to build, thus it is difficult for them to create momentum. With support, organization and focus they can accomplish great things.

The Activist/Scholar combination can often be described as the “Absent-Minded Professor”. An easy way to tell whether people with this combination lean more toward Activist or Scholar is to look at their hair. If his hair tends to be neat with a shorter cut then his predominant Character Code is Scholar. If his hair tends to look more windblown, unruly or overgrown, then his predominant Character Code is Activist. This also tells you whether the driving need for connection or certainty is most important to him. This combination often wants to engage with people and connect over topics they find of interest and may converse at length. They tend to be less aware of social graces and sometimes present as awkward or clumsy. When angry, this combination can tend toward passive-aggressive behavior or holding grudges.

The Class President/Scholars are not people persons. They are very task oriented, have a strong driving need for certainty and want things done the “right” way. They are often removed emotionally and prefer empirical data over experiential perceptions. They are likely to say “Where is the evidence?” They are often minimalists, can be rigid in their body stance and show up wearing tailored clothing with clean lines in neutral or dark colors and feel safest when the rules are followed. They can be very exacting and literal.

Although specific embodiments have been illustrated and described herein, those of ordinary skill in the art will appreciate that any arrangement calculated to achieve the same purposes can be substituted for the specific embodiments or exemplary methods shown, such as the substitution of various combinations of character types. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above methods are used. Therefore, the scope of various embodiments of the invention should be determined with reference to the appended claims, along with the full range of equivalents to which such claims are entitled.

In the foregoing description, if various features are grouped together in a single embodiment for the purpose of streamlining the disclosure, this method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims and such other claims as may later be added, are hereby incorporated into the description of the embodiments of the invention, with each claim standing on its own as a separate preferred embodiment.

What is claimed is:

1. A method of analyzing an individual and interacting most effectively therewith, the method comprising:
a. analyzing an individual by assessing details of appearance, presentation, and verbal communication to determine at least one of a character pattern selected from the group consisting of an Actress, Class President, a Cheerleader, a Scholar, an Activist, and an Artist;
b. using the determined character type to establish an individual's likely propensities in areas selected from needs, traits, negative internal drivers, conflict/stress/emotions, health/wellness, jobs/careers, and reaction to marketing sales;
c. sorting through the likely propensities of the individual to determine if that individual is an ideal client or colleague for personal development, awareness, business, sales, marketing, conflict resolution, personal relationships, parenting, or professional relationships; and
d. tailoring the direction of the marketing, selling, communications or other interaction to the individual's propensities.

2. The method of claim 1 wherein the details of appearance comprise hair style and grooming, application and choices of makeup, choice and wearing of accessories, style and length of nails, facial and body grooming, style and selection of clothing types of personal carry bag, and footwear.

3. The method of claim 1 wherein the details of presentation comprise demeanor, bodey stance, posture, carriage, movement such as pacing, eye contact, physical distance between individuals, body language such as hand gestures, facial expressions, energy level, actions and attitude.

4. The method of claim 1 wherein the details of verbal communication comprise word usage, tone, inflection, speed, sound and typical phrases.

5. The method of claim 1 wherein the details of driving needs comprise certainty, variety, significance, connection, predictability, control, adventure, newness, vulnerability, humanity, uniqueness and individuality.

6. The method of claim 1 wherein the character pattern of Actress comprises significance, uniqueness, individuality, big hair, full makeup, dramatic jewelry, bright clothing, dramatic or brightly colored shoes, talkative, projecting power, and high energy.

6. The method of claim 1 wherein the character pattern of Activist comprises connection, vulnerability, humanity, longer and less styled hair, slight makeup, natural-material jewelry, natural-fiber, earth-toned clothing, comfortable shoes, calming energy, and hugging.

7. The method of claim 1 wherein the character pattern of Artist comprises significance, uniqueness, individuality, stylized and colored hair, eclectic clothing, wide range of foot coverings,

8. The method of claim 1 wherein the character pattern of Cheerleader comprises variety, adventure, newness, friendliness, neighborly image, shoulder-length hair, full makeup, feminine or metrosexual clothing, romantic jewelry, up-beat, talkative, connecting with people, encouraging others, and interrupting to share an idea.

9. The method of claim 1 wherein the character pattern of Class President comprises certainty, predictability, control, professional image, driven, powerful, tasteful haircut; classic jewelry, tailored clothing that is often black, making eye contact, accomplished and effective.

10. The method of claim 1 wherein the character pattern of Scholar comprises certainty, predictability, control, studious, analytical, methodical, minimal or absent makeup, simple clothing, practical shoes, minimal or no jewelry, limited eye contact, task oriented, trouble shooters, creative, deliberative and questioning.
